(19) United States
(12) Patent Application Publication
(10) Pub. No.: US 2020/0264203 A1
(43) Pub. Date: Aug. 20, 2020

(54) PARTICLE DETECTION SYSTEM AND SWABS WITH INTEGRAL, MACHINE-READABLE IDENTIFICATION DATA

(71) Applicant: 1st Detect Corporation, Austin, TX (US)

(72) Inventors: Bryant Tran, Dickinson, TX (US); Offie Lee Drennan, League City, TX (US); Thomas Pickens, III, Austin, TX (US); Rajesh Mellacheruvu, Austin, TX (US)

(73) Assignee: 1st Detect Corporation, Austin, TX (US)

(21) Appl. No.: 16/277,938

(22) Filed: Feb. 15, 2019

(51) Int. Cl. G01N 35/00; H01J 49/04; H01J 49/00; G06K 19/07; G06K 19/06

(52) U.S. Cl. CPC G01N 35/00732; H01J 49/0409; H01J 49/0031; G01N 2035/00742; G06K 19/06037; G06K 19/06028; G01N 2035/00752; G06K 19/0723

(57) ABSTRACT

A system and method include a swab, configured to collect particles for detection by a particle detection system, that includes integral, machine-readable identification data that identifies the swab and is used by the particle detection system to at least activate one or more functions of the particle detection system associated with an efficacy of the swab for use by the particle detection system.

### BACKGROUND OF THE INVENTION

### Field of the Invention

The present invention relates in general to the field of particle detection, and more specifically to particle detection using swabs having integral, machine-readable identification data.

### Description of the Related Art

Law enforcement and screening personnel are often tasked with detecting security threats and other illegal activity. Facilities often employ particle detection systems that can detect suspicious chemical compounds, such as compounds from explosives, chemical warfare agents, illegal drugs, toxic industrial chemicals and explosives.

To detect the chemical compounds, an operator often wipes a swab across a surface of an item to collect a sample of any chemicals present on the surface. For example, a security agent at an airport can wipe a swab across a surface of a suit case to collect a sample of any chemicals present on the surface. The security agent then inserts the swab into a desorber of the particle detection system. The particle detection system then utilizes a technique, such as mass spectrometry, to detect chemical compounds collected on the swab.

The swabs used to collect the chemical compounds are specialized to effectively collect chemical compounds are often manufactured with a specific coating and a specific fabric weave to create a suitable collection surface. Consequently, the cost of the swabs is not trivial. To reduce costs, swabs are often reused. However, the compound collection efficiency of the swab diminishes as reuse continues. Eventually the swab can become ineffective in sufficiently collecting the chemical compounds to allow the particle detection system to detect chemical compounds of interest. The swabs become compromised through, for example, pores filling with particles that block collection of new particles, worn off coatings, and damaged fabric weave. Additionally, reuse of the swabs can create background noise for the particle detection system, which can increase false alarms. Thus, the number of reuses is limited.

Furthermore, the possibility exists to intentionally or unintentionally thwart the particle detection system by, for example, overusing a swab or utilizing a swab that is not certified with the particle detection system.

### SUMMARY OF THE INVENTION

In at least one embodiment, an apparatus includes a swab configured to collect particles for detection by a particle detection system. The swab includes integral, machine-readable identification data that identifies the swab and is used by the particle detection system to at least activate one or more functions of the particle detection system associated with an efficacy of the swab for use by the particle detection system.

In at least one embodiment, a method for manufacturing a swab for use by a particle detection system includes affixing machine-readable identification data to the swab that identifies the swab for use by the particle detection system to at least activate one or more functions of the particle detection system associated with an efficacy of the swab for use by the particle detection system.

In at least one embodiment, a method of operating a particle detection system with a swab includes reading machine-readable identification data included in a swab, wherein the swab includes integral, machine-readable identification data that identifies the swab and is used by the particle detection system to at least activate one or more functions of the particle detection system associated with an efficacy of the swab for use by the particle detection system. The method further includes determining if the read machine-readable identification data indicates that the efficacy of the swab is suitable to be used by the particle detection system to detect any particles captured by the swab. The method also includes operating the particle detection system in accordance with the determination of the efficacy of the swab.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary particle detection system that includes swab data processor.

FIG. 2 depicts an exemplary swab data processing and particle detection algorithm.

FIG. 3 depicts an exemplary swab efficacy authorization response process.

FIG. 4 depicts an exemplary collection of graphical user interfaces for a particle detection machine having an integrated reader.

FIG. 5 depicts an exemplary particle detection system.

FIG. 6 depicts an exemplary collection of graphical user interfaces for a particle detection machine having an external reader.

FIGS. 7-11 depict various swab designs.

FIG. 12 depicts exemplary optical, machine-readable representation of data.

FIG. 13 depicts swabs having a specific weave pattern and respective printed barcode.

FIG. 14 depicts an exemplary swab having a radio frequency identification circuit.

FIG. 15 depicts an exemplary particle detection machine 1500 having an integrated reader.

### DETAILED DESCRIPTION

A system and method include a swab, configured to collect particles for detection by a particle detection system, that includes integral, machine-readable identification data that identifies the swab and is used by the particle detection system to at least activate one or more functions of the particle detection system associated with an efficacy of the swab for use by the particle detection system. The particular type of identification data is a matter of design choice and is, for example, an optical, machine-readable representation of data using any type of pattern, punch card patterns, and electronically stored data, such as in a radio frequency identification (RFID) device that is integrated into the swab. The particle detection system includes one or more sensors, such as a barcode or quick response (QR) code scanner or an RFID sensor, that reads the identification data.

A swab data processor in the particle detection system processes the read identification data and activates a function of the particle detection system associated with an efficacy of the swab for use by the particle detection system. In at least one embodiment, the efficacy of the swab refers to an ability of the swab to collect samples of particles sufficient for the particle detection system to detect particles of interest. The particular particles of interest are a matter of design choice and include, for example, explosives, chemical and biological warfare agents, illegal drugs, and toxic chemicals.

The particular function is a matter of design choice. In at least one embodiment, the function exerts some amount of control over the particle detection system. For example, in at least one embodiment, the function is an authorization function that determines whether the swab can be used by particle detection system. The particular rules for preventing authorization of use of the swab is a matter of design choice. For example, in at least one embodiment, the identification data can be used to determine the total usage of the swab, cross-check the swab with an identification of an operator of the particle detection system, cross-check the swab and authorization to use the swab with the particle detection system, and/or generate an alert to replace the swab without deauthorizing any functionality of the particle detection system.

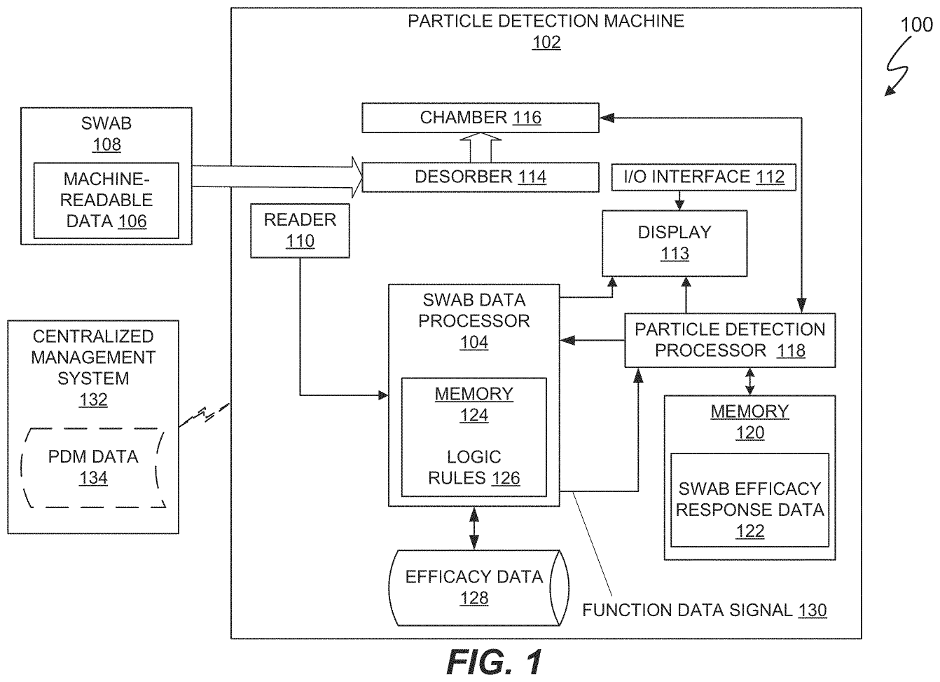

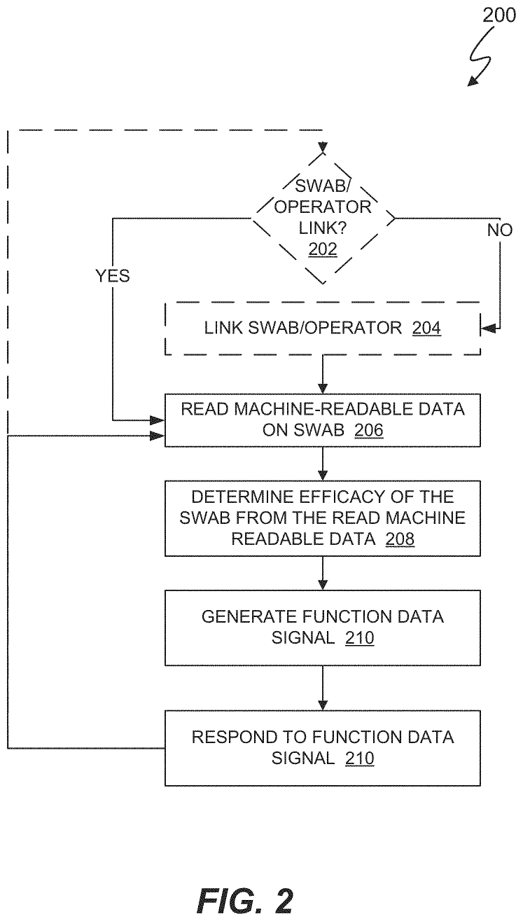

FIG. 1 depicts an exemplary particle detection system 100 that includes a particle detection machine 102 having swab data processor 104 to read the machine-readable data 106 of swab 108. The phrase “machine-readable data” represents a placeholder for actual data. FIG. 2 depicts an exemplary swab data processing and particle detection algorithm (SDP-PDA) 200. In at least one embodiment, the particle detection system 100 operates in accordance with the SDP-PDA 200. Referring to FIGS. 1 and 2, in at least one embodiment, particle detection machine 102 an operator (not shown) is logged into the particle detection machine 102, and the particle detection machine 102 maintains a record of logins and corresponding operator identifiers. In optional operation 202, if the particle detection machine 102 has not linked swab 108 with the operator, optional operation 204 registers swab 108 and links the swab 108 with the current operator. In at least one embodiment, the registration and linking in operation 204 occur automatically when the machine-readable data 106 is first read by reader 110.

the operator manually links the swab 108 through data entry via I/O interface 112, such as a physical or virtual keyboard displayed on display 113 or via an external device such as a universal serial bus (USB) drive containing an efficacy database. The swab 108 can be registered and linked to an operator before or after first use of the swab 108. In at least one embodiment, the reader 110 can also be used to login and authorize an operator to use the particle detection machine 102. For example, in at least one embodiment, as part of an operator login process, the swab data processor 104 links a unique identifier of the swab 108 in the machine readable data 106 with a unique identifier of the operator that is logging into the particle detection machine 102.

By linking the swab 108 with a specific operator, the particle detection machine 102 can perform any number of functions, such as tracking swab 108 use and particle sensing outcome data to a particular operator. For example, if swab 108 has been used beyond a recommended number of uses, any operator excessively reusing the swab 108 can be identified. The overuse may not be intentional but may present an educational opportunity. In at least one embodiment, the particle sensing outcome data can be correlated to the operator and compared with statistical expected outcomes, e.g. an expected average positive result for every X number of uses. However, operations 202 and 204 are optional, and, in at least one embodiment, the particle detection machine 102 operates without linking the swab 108 to the operator.

The swab 108 is designed to collect particle samples by, for example, wiping the swab 108 across a surface. The particular design and fabrication of the swab 108, such as a specific particle adherence and wear-resistant surface coating, specific collecting material, specific configuration of the collecting material (such as a specific weave pattern) to create a suitable particle collector is a matter of design choice.

The particular method of detecting particles by the particle detection machine 102 is a matter of design choice. Exemplary particle detection methods utilize electron-transfer disassociation (ETD) and infrared based technologies. In at least one embodiment, the Tracer series ETD devices manufactured by 1^{st} Detect of Texas, USA represent embodiments of the particle detection machine 102. A particle detection process used by the particle detection machine 102 to analyze the swab 108 and detect particles of interest is a matter of design choice. ETD is a method of fragmenting multiple-charged gaseous particles, such as macromolecules in a mass spectrometer. In at least one embodiment, the particle detection machine 102 is an ETD device and the particle detection process utilized by the particle detection machine 102 is an analytical technique called mass spectrometry to detect particles, such as chemical compounds, collected on swab 108. In at least one embodiment, an operator wipes swab 108 across a surface of an item and inserts the swab into a heated desorber 114. The heat from the desorber 114 helps release the particles trapped on the swab 108 into the chamber 116. After releasing the particles, the particles are drawn into an ion source of the chamber 116 where the particles are ionized, meaning a positive or negative charge is added to the particles. Sometimes, the ionization process breaks the particles apart into smaller fragments that can also be charged. Mass to charge (m/z) ratios of the charged particles and fragments are then measured by a mass analyzer of the chamber 116, which is a linear ion trap. The particle detection processor 118 uses the m/z measurements to create a plot called a mass spectrum, which shows how much of each ion m/z is present. Each particle produces a unique mass spectrum which can be identified by a library in the swab efficacy response data 122 portion of memory 120. When the particle detection machine 102 detects a particle of interest, the particle detection machine 102 issues an alert, such as, an alerting image and/or sound on the display.

The machine-readable data 106 allows the swab 108 to at least be particularly identified by the particle detection machine 102. The specificity of the identification is a matter of design choice. In at least one embodiment, the machine-readable data 106 is unique to the swab 108 and allows the swab 108 to be uniquely identified. In at least one embodiment, the machine-readable data 106 is more specific and contains additional information about the swab, such as an identifier (such as a serial number), an identification of the particular side of the swab 108 that includes the machine readable data 106 (for example, an “A” side and a “B” side), an identifier of the particle detection machine 102 (such as a serial number), one or more anti-cloning features, a manufacturer identifier, construction materials, expected life, age, restrictions, an expiration date, maximum number of uses, and/or any other useful information. The machine-readable data 106 can also be less specified and, for example, only identify parameters that may not be unique to the swab 108. The method of affixing the machine-readable data 106 to the swab 108 is a matter of design choice, such as through labels, direct printing, or embedding, and is discussed in more detail below. For purposes of this disclosure, regardless of how the machine-readable data 106 is affixed, the machine-readable data 106 becomes an integral part of the swab 108.

The particular medium of the machine-readable data 106 is also a design choice. In at least one embodiment, the machine-readable data 106 is an optical, machine-readable representation of data of any design. Examples of optical, machine-readable representation of data are barcodes, quick response (QR) codes, weave patterns in the material of the swab 108, and patterns of material, such as colored thread, woven into the material of the swab 108. In at least one embodiment, the machine-readable data 106 is contained in an electronic medium, such as a radio frequency identification (RFID) device. In at least one embodiment, the machine-readable data 106 includes anti-cloning technology. The particular type of anti-cloning technology is a matter of design choice and includes, for example, applying any anti-cloning algorithm or encryption. The method of encryption is a matter of design choice, such as public key infrastructure (PKI) encryption. Encrypting the machine-readable data 106 can assist in preventing use of unauthorized swabs. For example, in at least one embodiment, using PKI encryption, the machine-readable data 106 is encrypted with a public key associated with the particle detection machine 102, and the particle detection machine 102 decrypts the machine-readable data 106 with a corresponding private key.

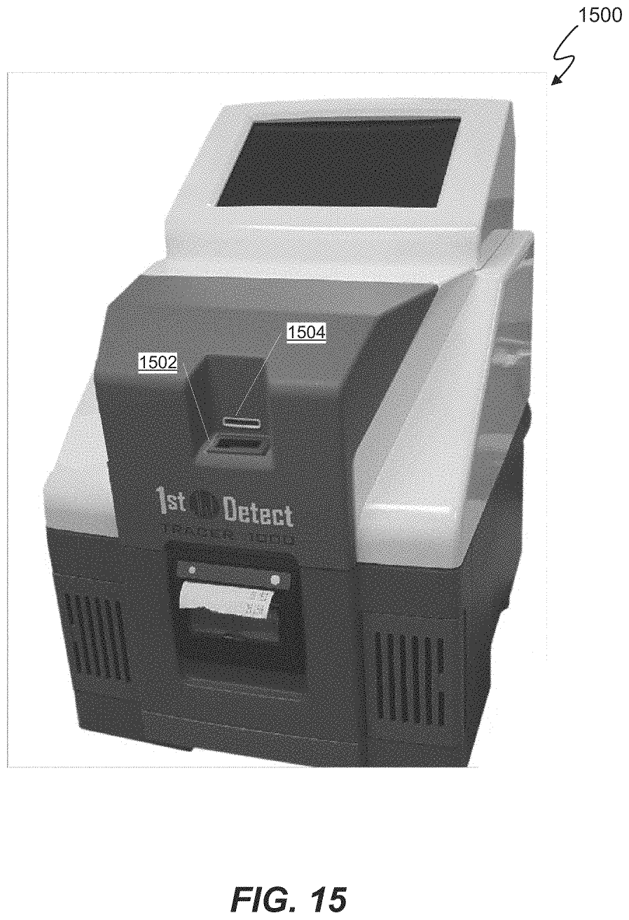

In at least one embodiment, the particle detection machine 102 includes the reader 110, which, in at least one embodiment, is integral to the particle detection machine 102, i.e. the reader 110 is located in the particle detection machine 102. Locating the reader 110 in the particle detection machine 102 can provide some advantages. For example, if a swab 108 is inserted into desorber 114 the particle detection machine 102 recognizes any attempt to withdraw the swab 108, such as by sensing motion of the machine-readable data 106 after insertion of the swab 108 into the desorber 114. Thus, an integrated reader 110 can present at least an obstacle or even prevent the machine-readable data 106 of swab 108 from being read and another swab substituted for the read swab 108. The particular positioning of reader 110 to allow the reader 110 to read the machine-readable data 106 of swab 108 is a matter of design choice and may be constrained by the type of machine-readable data 106. For example, for an optical, machine-readable representation of data, the reader 110 is a sensor such as a barcode or QR code reader positioned to capture light reflected from the machine-readable data 106. In at least one embodiment, the reader 110 is integrated into a position proximate to an entry slot of the desorber 114 (as shown and discussed in conjunction with FIG. 15). In at least one embodiment, the reader 110 is located in visual proximity to the desorber 114. In at least one embodiment, a transparent material separates the reader 110 from the desorber 114 to protect the reader 110 from heat of the desorber 114 while still allowing light to pass through. The desorber 114 could be located further away and utilize an optical or optical/electronic transmission system to allow the reader 110 to read the machine-readable data 106. In at least one embodiment, for an electronic representation of the machine-readable data 106, such as an RFID circuit, the reader 110 is located in electronic proximity to detect a transmission of the machine-readable data 106. In at least one embodiment, integrating the reader 110 with the particle detection machine 102 automates reading the machine readable data 106, which can eliminate user errors, recognizing improper withdrawals or substitutions of the swab 108, improper disposal of the actual read swab 108 including mismatching a read swab 108 with a different swab inserted into particle detection machine 102.

Referring to FIGS. 1 and 2, in operation 206, reader 110 reads the machine-readable data 106 and decrypts any authorized encryption of the machine-readable data 106. The reader 110 transfers the read machine-readable data 106 to the swab data processor 104. In operation 208, the swab data processor 104 determines the efficacy of the swab from the read machine-readable data 106. The particular measure or measures of efficacy are a matter of design choice. For example, in at least one embodiment, the efficacy of the swab is one or more members of a group of parameters stored as efficacy data 128 that includes (i) an ability of the swab to collect samples of particles sufficient for the particle detection system to detect particles of interest, (ii) manufactured by a manufacturer registered with the particle detection system, (iii) fabrication with construction materials registered with the particle detection system. (iv) a non-exceeded, life, such as a maximum number of uses, (v) a non-exceeded age, (vi) restricted usage, (viii) an expiration date, and/or (ix) any other useful information.

The process of determining the efficacy of the swab 108 from the read machine-readable data 106 is a matter of design choice. In at least one embodiment, the swab data processor 104 includes a memory 124 that includes logic rules 126 that are executable by the swab processor 104 and can access the stored efficacy data 128, and/or are hard-coded into the swab data processor 104, to process the machine-readable data 106 to determine the efficacy. In at least one embodiment, logic rules 126 are incorporated into a program that is executable by the swab data processor 104 and stored in the non-transitory, computer readable medium of memory 124. In at least one embodiment, the swab data processor 104 determines efficacy based on one or a plurality of the parameters.

In at least one embodiment, the swab data processor 104 tracks a number of uses of the swab 108 by, for example, incrementing a counter in the swab data processor 104 each time the machine-readable data 106 is read by reader 110. The logic rules 126 compare the then-current usage count with the maximum number of uses to determine whether the useful life of the swab 108 is approaching or reached and can display the remaining uses. In at least one embodiment, the logic rules 126 determine efficacy based on an age of the swab 108. For example, a maximum age from time of manufacture of the swab 106 may be “X” years, where “X” is a real number. Then, the logic rules 126 can include a comparison function to compare a read date of the swab 108 with a time of manufacture stored in memory 102 and determine whether the swab 108 is too old to use. If the machine-readable data 106 includes an expiration date, then the logic rules 126 executed by the swab data processor 104 an include a comparison function to compare a current date with the expiration date to determine if continued use of the swab 108 is advisable or allowable. In at least one embodiment, utilizing a comparison function, the logic rules 126 can determine if the manufacturer indicated by the machine-readable data 106 is registered in memory 124. In at least one embodiment, the fabrication construction can affect the expected life of the swab 108. Accordingly, the logic rules 126 can match the fabrication construction parameter with a table in efficacy data of expected life for a variety of fabrication construction. Upon matching the fabrication construction parameter with an expected life, the logic rules 126 compare, for example, the age or maximum expected use parameters with the matched expected life. The foregoing examples, identified parameters, and capabilities of the logic rules 126 and swab data processor 104 are not comprehensive and can be expanded or contracted as a matter of design choice.

The particle detection machine 102 uses the read machine-readable data to at least activate one or more functions of the particle detection system 100 associated with the determined efficacy of the swab 108. In operation 210, the swab data processor 104 generates function data signal 130 and provides the function data signal 130 to the particle detection processor 118. In at least one embodiment, the function data signal 130 represents an outcome of operation 208. In at least one embodiment, in operation 210 the particle detection processor 118 accesses memory 120 and the swab efficacy response data 122 to determine a response to the function data signal 130. In at least one embodiment (not shown), the particle detection processor 118 includes circuitry that is hard-wired to respond to the function data signal 130. In at least one embodiment, memory 120 is a non-transitory, computer readable medium that stores a program that is executable by the particle detection processor 118 to perform programmable functions of the particle detection processor 118. In at least one embodiment, when the swab data processor 104 determines that the efficacy of the swab 108 is sufficient to be processed by, for example, the previously described particle detection process, the function data signal 130 enables the particle detection machine 102 to process the swab 108 in accordance with the particle detection process.

In at least one embodiment, the particle detection machine 102 includes communication circuitry, such as a wireless transmitter/receiver (not shown), to communicate with a centralized management system 132 through a communication network, such as the Internet. In at least one embodiment, the centralized management system 132 provides particle detection machine (PDM) data 134 to particle detection machine 102, and/or particle detection machine 102 provides swab efficacy results to the centralized management system 132. Exemplary PDM data 134 can revise the logic rules 126 and the swab efficacy response data 122. In at least one embodiment, the centralized management system 132 can also process the swab efficacy results and issue responsive commands to the particle detection machine 102.

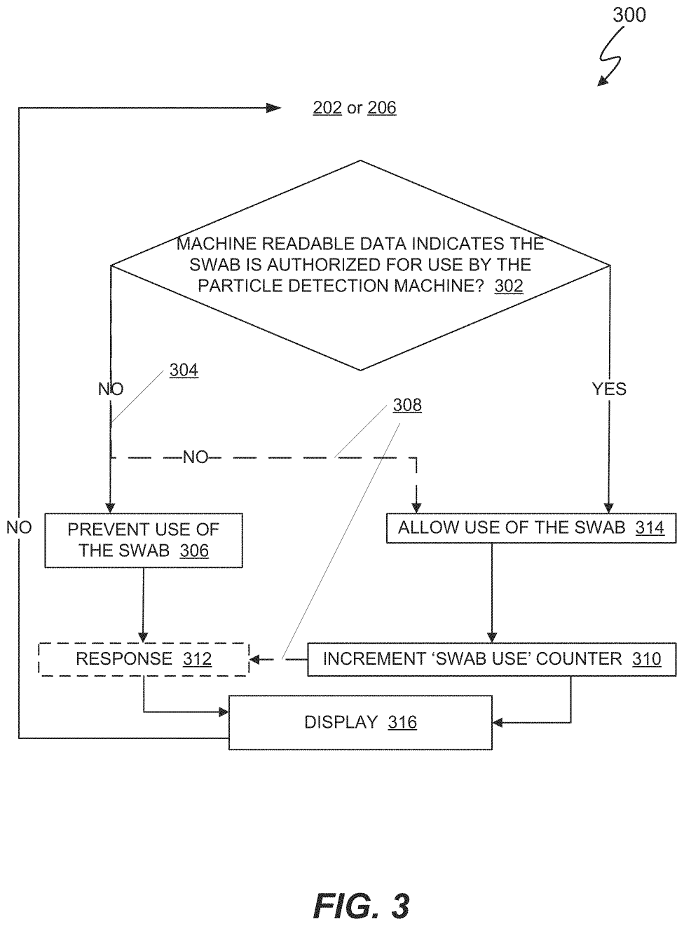

The particle detection processor 118 particular response to the efficacy determination of swab 108 based on the machine-readable data 106 is a matter of design choice. In at least one embodiment, the response to the read machine-readable data 106 by the particle detection processor 118 is to either authorize or not authorize use of the swab 108 by particle detection machine 102. FIG. 3 depicts an exemplary swab efficacy authorization response process 300 to the function data signal 130 that, in at least one embodiment, accepts or rejects swab 108. The swab efficacy response 300 represents an exemplary embodiment of operation 210. In operation 302, the particle detection processor 118 determines from the function data signal 130 if the machine-readable data 106 indicates the swab 108 is authorized for use by the particle detection machine 102. If the particle detection processor 118 determines that the swab 108 is unauthorized for use, in the embodiment depicted by the solid line 304, the particle detection processor 118 in operation 306 rejects swab 108 and, thus, prevents use of the swab 108. The particle detection processor 118 then optionally issues a response 312, such as a report, alert, or an instructional response, indicating that the swab 108 is potentially compromised and, thus, the corresponding particle detection results may be inaccurate. Alternatively, as depicted by the dashed lines 308, particle detection processor 118 allows use of the particle detection machine 102 to process the swab 108, increments a swab use counter in operation 310, and also issues the response 312. In at least one embodiment, the swab use counter is incremented after both detecting the machine readable data 106 by reader 110 and analyzing the swab for the presence of particles of interest.

If the particle detection processor 118 determines that the swab 108 is authorized for use, the particle detection processor 118 in operation 314 allows use of the swab 108 by particle detection machine 102 to perform the particle detection process and also increments a swab use counter in operation 310. Operation 316 displays the authorization and particle detection results on display 113. The swab efficacy authorization response 300 then returns to operations 202 or 206 as previously described.

Operation 210 can respond to the function data signal 130 representing the determined efficacy of the swab 108 in any number of additional or alternative ways. For example, in at least one embodiment of operation 210 when the efficacy of the swab 108 is compromised or questionable, particle detection processor 118 issues an alert only but allows continued use of particle detection machine 102, deauthorizes continued use of particle detection machine 102, issues an alert or message indicating potential inaccuracies of the particle detection results, a pre-alert if the efficacy of the swab 108 is approaching in a next or near subsequent use, and/or compromise of the particle detection machine 102 due to unauthorized use, and so on.

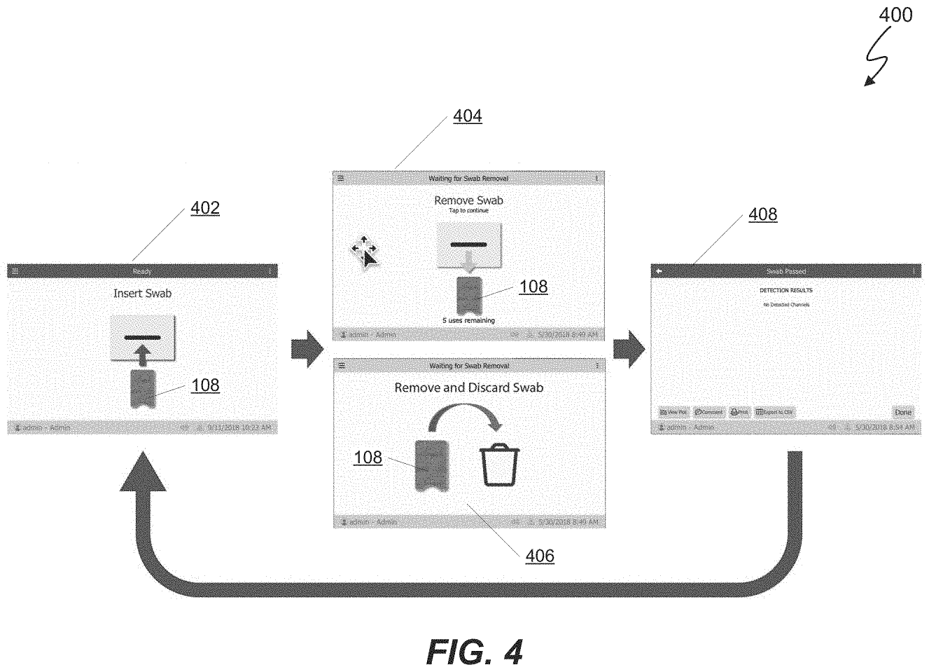

FIG. 4 depicts an exemplary collection of graphical user interfaces (GUI's) 400 displayed on display 113 for particle detection machine 102 having an integrated reader 110. GUI 402 instructs and illustrates insertion of the swab 108 into the desorber 114 entry slot. GUI 404 illustrates removal of the swab 108 from the desorber 114 and indicates 5 uses remaining. GUI 406 illustrates a rejected swab 108 and an instructional response to remove and discard the rejected swab 108. GUI 408 displays results of the particle detection process, and in the depicted embodiment indicates that the particle detection machine 102 did not detect any particles of interest.

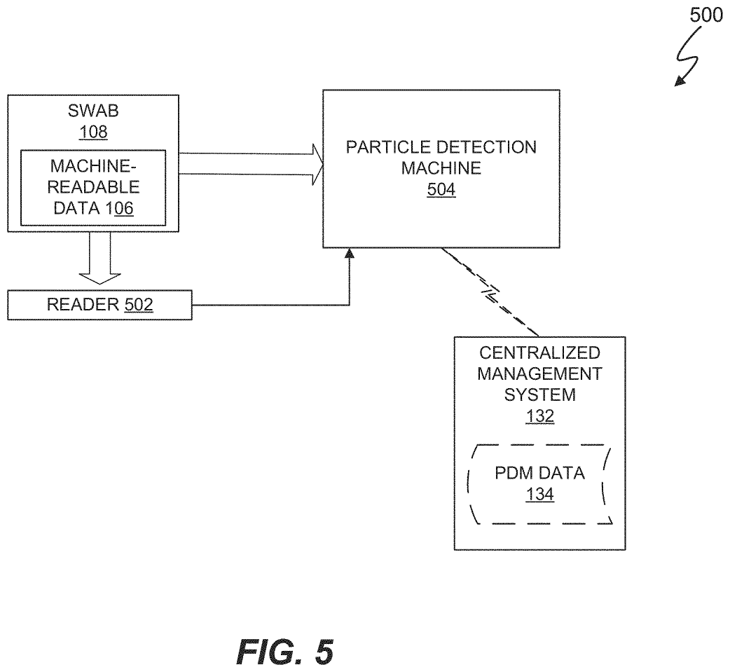

FIG. 5 depicts particle detection system 500. Particle detection system 500 is identical to particle detection system 100, except particle detection system 500 includes an external reader 502, and, in at least one embodiment, particle detection machine 504 does not include an integrated reader 110. The external reader 502 functions in the same manner as reader 110 and communicates the read machine-readable data 106 to particle detection machine 502, which processes the machine-readable data 106 as described in conjunction with particle detection machine 102. In at least one embodiment, the particle detection machine 504 also includes an integrated reader 110, and external reader 502 serves as a backup to the integrated reader 110. The particular design of external reader 502 is a matter of design choice and is, for example, either fixed or hand manipulable.

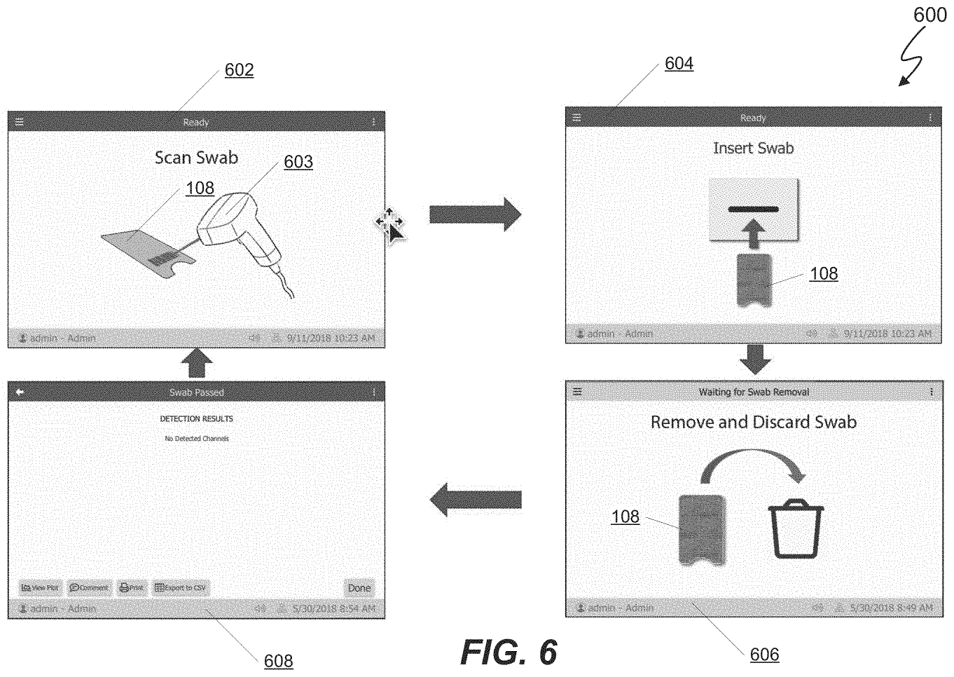

FIG. 6 depicts an exemplary collection of graphical user interfaces (GUI's) 600 displayed on display 113 for particle detection machine 504 having an external reader 110. GUI 402 instructs and illustrates scanning the swab 108 by a hand manipulable scanner 603. GUI 604 depicts insertion of the swab 108 into the desorber entry slot. GUI 606 illustrates removal and discarding swab 108 because the particle detection machine 504 determined that the swab 108 has reached a maximum number of reuses. GUI 408 displays results of the particle detection process, and in the depicted embodiment indicates that the particle detection machine 102 did not detect any particles of interest.

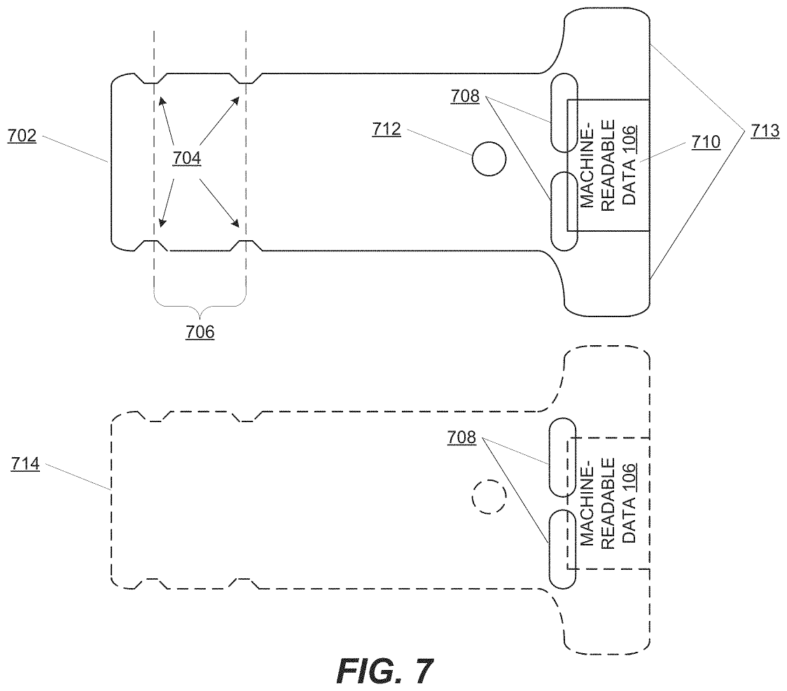

FIGS. 7-11 depict various swab designs, which represent exemplary embodiments of swab 108. Swab 702 includes notches 704 that visually demarcate an area 706 of the swab 702 for wiping on an article and collecting available particles. Swab 702 also includes two slots 708 that allow a label 710 to be affixed to the swab 702 by passing adhesive tabs through the slots 708 and attaching to counterparts of the tabs on the identical reverse side of swab 702. The optional hole 712 provides an attachment point for a wand (not shown) used by an operator to hold the swab 702. Extensions 713 provide a visual indication of how far to insert the swab 702 into desorber 114. Swab 714 is identical to swab 702 and illustrates the slots 708 and indicates in dotted lines that the remaining features are a matter of design choice.

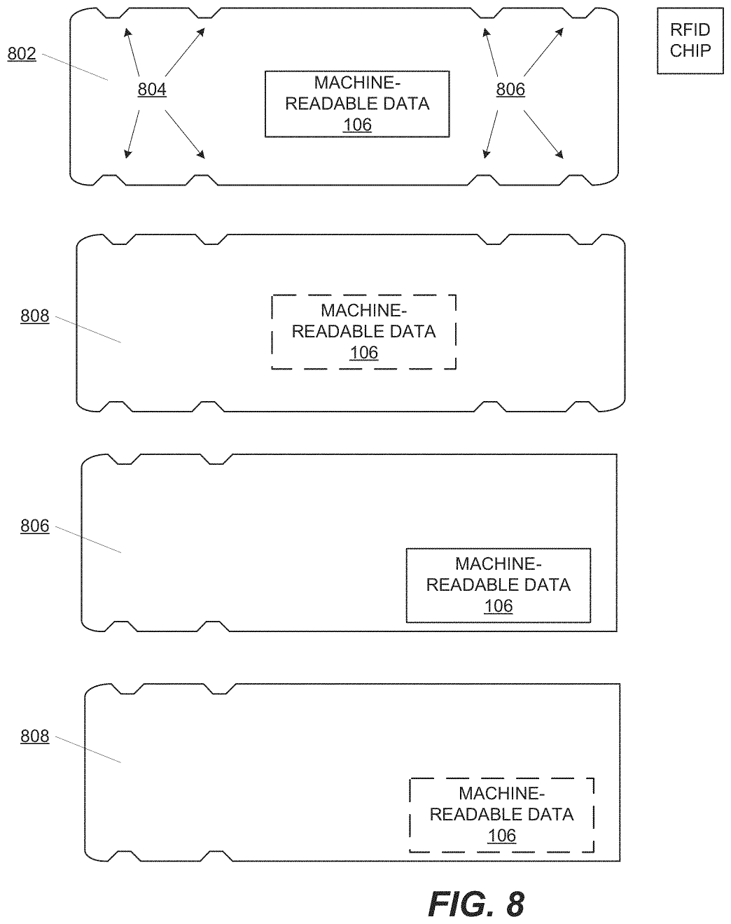

FIG. 8 depicts swab 802, which includes notches 804 and 806 on each end of swab 802. Notches 804 and 806 serve the same purpose as notches 704. However, by placing the notches 804 and 806 on opposite ends of swab 802, swab 802 is bidirectional and can be inserted into particle detection machine 102 on either end. In at least one embodiment, the reader 110 detects the orientation of machine-readable data 106 to determine independently determine the efficacy of each end of swab 802. Swab 802 depicts the particular notches and symmetry on both ends in solid lines and indicates in dotted lines that the remaining features are a matter of design choice. Swabs 810 and 812 incorporates the notches of swab 702 without the extensions 713.

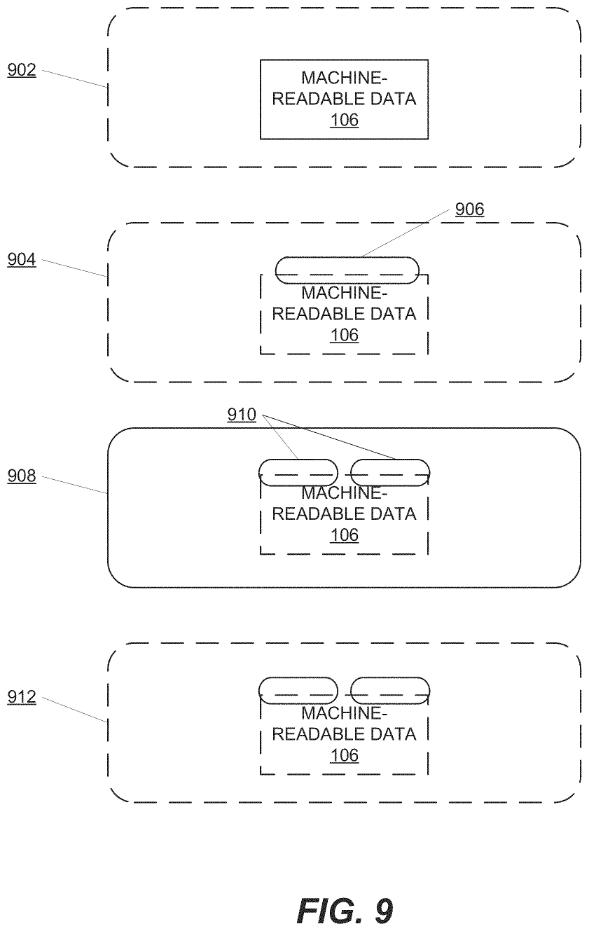

FIG. 9 depicts swab 902 with a center orientation of machine-readable data 106, and the perimeter outline of swab 902 is a matter of design choice. Swab 904 includes a single, elongated slot 906 that serves the same purpose as slots 708. Swab 908 includes slots 910 that serve the same purpose as slots 708 but are oriented along the length and near a center of swab 908. Swab 912 is identical to swab 908 and indicates in dotted lines features that are a matter of design choice. The particular shape and number of slots to, for example, accommodate affixing the machine readable data 106 to the swab is a matter of design choice.

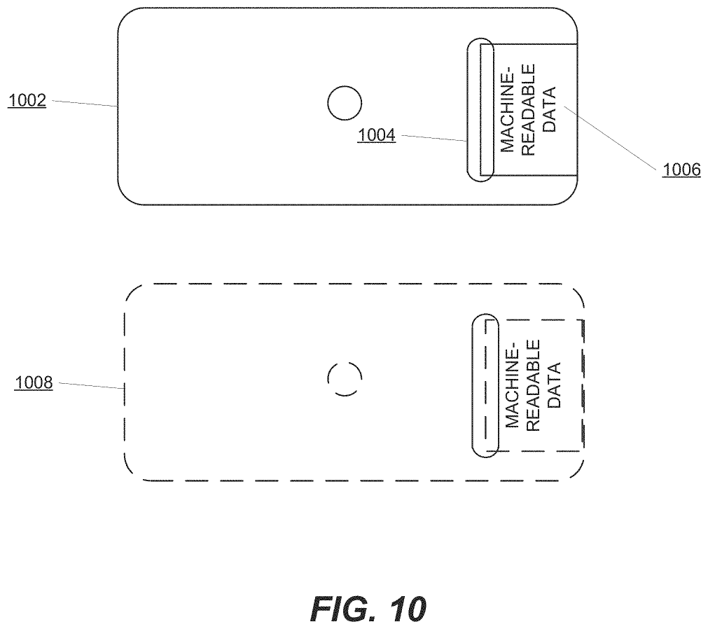

FIG. 10 depicts swab 1002 with a single slot 1004 to allow a label 710 to be affixed to the swab 1002 by passing an adhesive tab through the slot 1004 and attaching to counterparts of the tab on the identical reverse side of swab 1002. Swab 1008 is identical to swab 1002 and indicates in dotted lines features that are a matter of design choice.

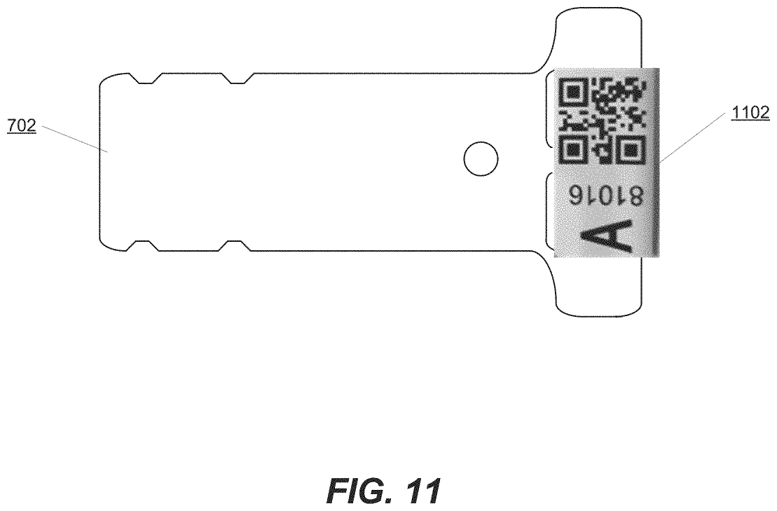

FIG. 11 depicts swab 702 having a label 1102 with QR code and text machine-readable data.

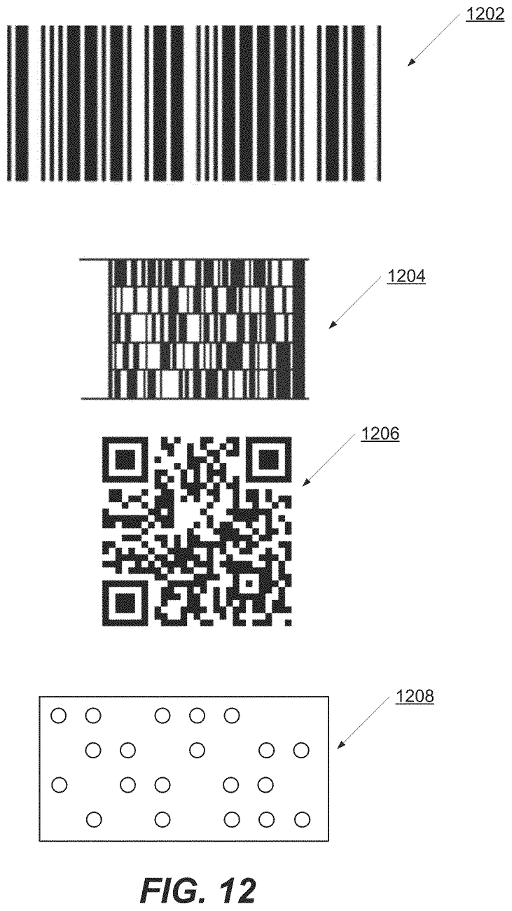

FIG. 12 depicts exemplary optical, machine-readable representation of data including barcodes 1202 and 1204, QR code 1206, and hole punch pattern 1208.

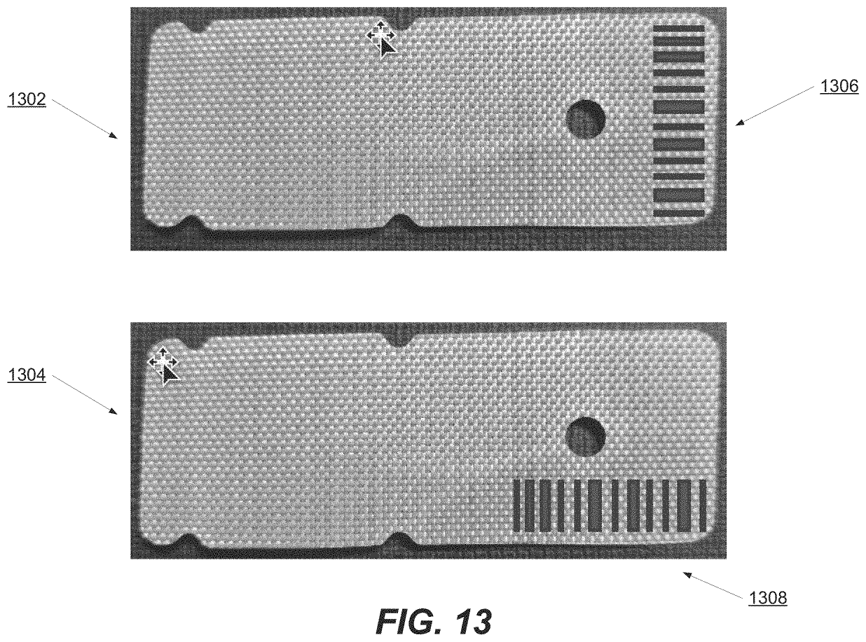

FIG. 13 depicts swabs 1302 and 1304 having a specific weave pattern and respective printed barcodes 1306 and 1308 with orientations varying by 90 degrees.

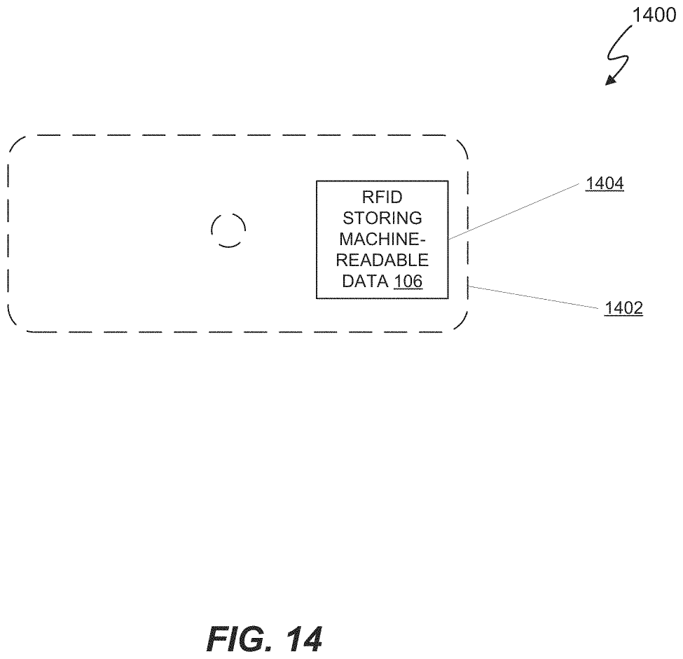

FIG. 14 depicts an exemplary swab 1402 having an RFID circuit 1404 storing the machine-readable data 106. The particular shape and material of swab 1402 is a matter of design choice.

FIG. 15 depicts an exemplary particle detection machine 1500 having an integrated reader 1502. The particle detection machine 1500 represents one embodiment of particle detection machine 102 and is a Tracer 1000 available from 1^{st} Detect of Texas, USA. The reader 1502 represents one embodiment of reader 110 (FIG. 10). Reader 1502 is positioned sufficiently proximate to the entry slot 1502 to allow the reader 1502 to read a swab, such as swab 108, as the swab is inserted into the entry slot 1504 of the particle detection machine 1500. The entry slot 1504 is an entry to a desorber (not shown), such as desorber 114, that is located directly behind the entry slot 1502. The particle detection machine 1500 also includes a display 1506 and an integrated printer that produces a printed response 1508 representing, for example, results of a particle detection process.

Thus, a system and method include a swab, configured to collect particles for detection by a particle detection system, that includes integral, machine-readable identification data that identifies the swab and is used by the particle detection system to at least activate one or more functions of the particle detection system associated with an efficacy of the swab for use by the particle detection system.

Although embodiments have been described in detail, it should be understood that various changes, substitutions, and alterations can be made hereto without departing from the spirit and scope of the invention as defined by the appended claims.

What is claimed is:

1. An apparatus comprising:
a swab configured to collect particles for detection by a particle detection system, wherein the swab includes integral, machine-readable identification data that identifies the swab and is used by the particle detection system to at least activate one or more functions of the particle detection system associated with an efficacy of the swab for use by the particle detection system.

2. The apparatus of claim 1 wherein the machine-readable identification data comprises a member of a group consisting of an optical, machine-readable representation of data and a radio frequency identification (RFID) device.

3. The apparatus of claim 2 wherein the optical, machine-readable representation of data comprises one of a barcode or a quick response code, the optical, machine-readable representation of data is printed on a label, and the label is affixed to the swab.

4. The apparatus of claim 2 wherein the optical, machine-readable representation of data comprises one of a barcode or a quick response code, and the optical, machine-readable representation of data is printed on the swab.

5. The apparatus of claim 1 wherein the particle detection system comprises a particle detection machine utilizing technology to detect particles of interest.

6. The apparatus of claim 1 wherein the technology utilized by the particle detection system comprises at least one of (i) mass spectrometry, electron-transfer disassociation technology and (ii) infrared technology.

7. The apparatus of claim 1 wherein the particle detection system comprises a sensor configured to read the machine-readable identification data.

8. The apparatus of claim 7 wherein the particle detection system includes an exterior shell that encloses at least partially a desorber that receives the swab, and the sensor is positioned in the particle detection system to read the machine-readable identification data as the swab is received in the desorber.

9. The apparatus of claim 1 wherein the particle detection system includes a particle detection machine, and the sensor is located within or attached to the particle detection machine.

10. The apparatus of claim 1 wherein the one or more functions of the particle detection system associated with an efficacy of the swab for use by the particle detection system comprises a function that determines if the swab is authorized for use with the particle detection system.

11. The apparatus of claim 10 wherein the particle detection system comprises a processor configured to execute the authorization function and cause the particle detection system to:
determine if the read machine-readable identification data indicates that the swab is authorized to be used by the particle detection system to detect any particles captured by the swab;
prevent use of the swab to detect any particles captured by the swab if the machine-readable identification data is determined to indicate that the swab is unauthorized to be used by the particle detection system; and
allow use of the swab to detect any particles captured by the swab if the machine-readable identification data is determined to indicate that the swab is authorized to be used by the particle detection system.

12. The apparatus of claim 11 wherein:
the particle detection system comprises a processor is further configured to cause the particle detection system to receive login data from an operator to authorize the operator to utilize the particle detection system;
the particle detection system includes a database that links the swab to (i) the particle detection system and (ii) an operator of the particle detection system; and
to determine if the read machine-readable identification data indicates that the swab is authorized to be used by the particle detection system to detect any particles captured by the swab comprises:
cross-checking the read machine-readable identification data against information in the database to determine if the operator is authorized to use the swab with the particle detection system.

13. The apparatus of claim 12 wherein the processor is programmable, and the particle detection system further comprises communication circuitry to couple the particle detection system to a network and receive programming updates for the processor and updates to the database.

14. The apparatus of claim 11 wherein upon prevention of the use of the swab to detect any particles captured by the swab if the machine-readable identification data, the particle detection system comprises a processor is further configured to issue an alert indicating potential unauthorized use.

15. The apparatus of claim 11 wherein the machine-readable identification data comprises a barcode, and the sensor is coupled to an input connector of the particle detection system.

16. The apparatus of claim 1 wherein the one of more functions of the particle detection system associated with an efficacy of the swab for use by the particle detection system comprises a function executable by the particle detection system to:
read the machine-readable identification data of the swab;
increment a counter each time the machine-readable identification data of the swab is read by the particle detection system;
determine if the counter indicates that the swab has been read by the particle detection system a maximum number of times;
determine that the swab is unauthorized to be used by the particle detection system if the swab has been read by the particle detection system the maximum number of times; and
determine that the swab is authorized to be used by the particle detection system if the swab has not been read and analyzed by the particle detection system the maximum number of times.

17. The apparatus of claim 1 wherein the one or more functions of the particle detection system associated with an efficacy of the swab for use by the particle detection system comprises a function that allows use of the swab with the particle detection system and issues an alert if the function determines that the efficacy of the swab is or is about to be compromised.

18. The apparatus of claim 1 wherein the machine-readable identification data is encoded, and the particle detection system is configured to decode the machine-readable identification data and determine whether the swab is authorized to be used with the particle detection system.

19. The apparatus of claim 1 wherein the efficacy of the swab comprises one or more members of a group consisting of (i) an ability of the swab to collect samples of particles sufficient for the particle detection system to detect particles of interest, (ii) manufactured by a manufacturer registered with the particle detection system, (iii) fabrication with construction materials registered with the particle detection system, (iv) a non-exceeded, expected life including a maximum number of uses, (v) a non-exceeded age, and (vi) an expiration date.

20. A method for manufacturing a swab for use by a particle detection system, the method comprising:
affixing machine-readable identification data to the swab that identifies the swab for use by the particle detection system to at least activate one or more functions of the particle detection system associated with an efficacy of the swab for use by the particle detection system.

21. A method of operating a particle detection system with a swab, the method comprising:
reading machine-readable identification data included in a swab, wherein the swab includes integral, machine-readable identification data that identifies the swab and is used by the particle detection system to at least activate one or more functions of the particle detection system associated with an efficacy of the swab for use by the particle detection system;
determining if the read machine-readable identification data indicates that the efficacy of the swab is suitable to be used by the particle detection system to detect any particles captured by the swab; and
operating the particle detection system in accordance with the determination of the efficacy of the swab.

22. The method of claim 21 wherein:
determining if the read machine-readable identification data indicates that the efficacy of the swab is suitable to be used by the particle detection system to detect any particles captured by the swab operating a particle detection system with a swab comprises:
determining if the read machine-readable identification data indicates that the swab is authorized to be used by the particle detection system to detect any particles captured by the swab; and
operating the particle detection system in accordance with the determination of the efficacy of the swab comprises:
preventing use of the swab to detect any particles captured by the swab if the machine-readable identification data is determined to indicate that the swab is unauthorized to be used by the particle detection system; and
if the machine-readable identification data is determined to indicate that the swab is authorized to be used by the particle detection system:
allowing use of the swab to detect any particles captured by the swab; and
detecting any particles captured by the swab.

23. The method of claim 22 wherein the particle detection system includes a database that links the swab to (i) the particle detection system and (ii) an operator of the particle detection system, the method further comprising:
receiving login data from an operator to authorize the operator to utilize the particle detection system;
determining if the read machine-readable identification data indicates that the swab is authorized to be used by the particle detection system to detect any particles captured by the swab comprises:
cross-checking the read machine-readable identification data against information in the database to determine if the operator is authorized to use the swab with the particle detection system.
